(19) United States
(12) Patent Application Publication
(10) Pub. No.: US 2015/0254541 A1
(43) Pub. Date: Sep. 10, 2015

(54) PRINT INSTRUCTION APPARATUS, PRINTING SYSTEM, PRINT INSTRUCTION METHOD, AND NON-TRANSITORY COMPUTER READABLE MEDIUM

(71) Applicant: FUJI XEROX CO., LTD., Tokyo (JP)

(72) Inventors: Hiroo YOSHIDA, Kanagawa (JP); Shinichi TAKANO, Kanagawa (JP); Yutaka KOJIMA, Kanagawa (JP); Masayuki IWASAWA, Kanagawa (JP); Taro YAMAZAKI, Kanagawa (JP); Naoki YASUDA, Kanagawa (JP); Issei MATSUSHITA, Kanagawa (JP); Shingo KATO, Kanagawa (JP)

(73) Assignee: FUJI XEROX CO., LTD., Tokyo (JP)

(21) Appl. No.: 14/485,952

(22) Filed: Sep. 15, 2014

(30) Foreign Application Priority Data
Mar. 4, 2014 (JP) 2014-042127

(51) Int. Cl. G06K 15/00; G06F 3/12; B65H 7/20

(52) U.S. Cl. CPC G06K 15/4025; B65H 7/20; G06F 3/1211; G06F 3/1237

(57) ABSTRACT

A print instruction apparatus includes a group information acquisition unit that acquires information identifying a feeder unit included in a group that includes two or more feeder units, from among feeder units arranged in a printer to feed paper sheets, and that is configured in a manner such that if one of the feeder units in the group runs out of paper sheets in a printing of the printer, another feeder unit in the group starts to feed paper sheets, and a display that acquires information related to a remaining amount of paper sheets or information related to an out-of-paper state in each of the feeder units in the group that is configured to feed paper sheets in the printing operation, and that displays information related to a feeder unit in the group that is to be replenished with paper sheets.

### CROSS-REFERENCE TO RELATED APPLICATIONS

This application is based on and claims priority under 35 USC 119 from Japanese Patent Application No. 2014-042127 filed Mar. 4, 2014.

### BACKGROUND

### Technical Field

The present invention relates to a print instruction apparatus, a printing system, a print instruction method, and a non-transitory computer readable.

### SUMMARY

According to an aspect of the invention, a print instruction apparatus is provided. The print instruction apparatus includes a group information acquisition unit that acquires information identifying a feeder unit included in a group that includes two or more feeder units, from among feeder units arranged in a printer to feed paper sheets, and that is configured in a manner such that if one of the feeder units in the group runs out of paper sheets in a printing operation of the printer, another feeder unit in the group starts to feed paper sheets, and a display that acquires information related to a remaining amount of paper sheets or information related to an out-of-paper state in each of the feeder units in the group that is configured to feed paper sheets in the printing operation, and that displays information related to a feeder unit in the group that is to be replenished with paper sheets.

### BRIEF DESCRIPTION OF THE DRAWINGS

Exemplary embodiments of the present invention will be described in detail based on the following figures, wherein:

FIG. 1 generally illustrates an image forming system of an exemplary embodiment;

FIG. 2 illustrates a functional configuration of a controller of the exemplary embodiment;

FIG. 3 illustrates a functional configuration of a terminal apparatus of the exemplary embodiment;

FIG. 4 illustrates a hardware configuration of the terminal apparatus;

FIG. 5 illustrates a group setting of a paper sheet feeder unit;

FIG. 6 illustrates an example of a first group setting screen on a user interface (UI) of the image forming apparatus;

FIG. 7 is a flowchart illustrating an operation example of the group setting on the image forming apparatus;

FIG. 8 illustrates an example of a paper feeding status screen displayed on a display mechanism of the terminal apparatus;

FIG. 9A illustrates paper feeding information and group setting information stored on a setting information memory, and FIG. 9B illustrates the paper feeding information and group setting information stored on a status database;

FIG. 10 is a flowchart illustrating an example of a display process of the paper feeding status screen; and

FIG. 11 illustrates an inhibition relationship of paper feeding in anther exemplary embodiment.

### DETAILED DESCRIPTION

Exemplary embodiments of the present invention are described below with reference to the drawings.

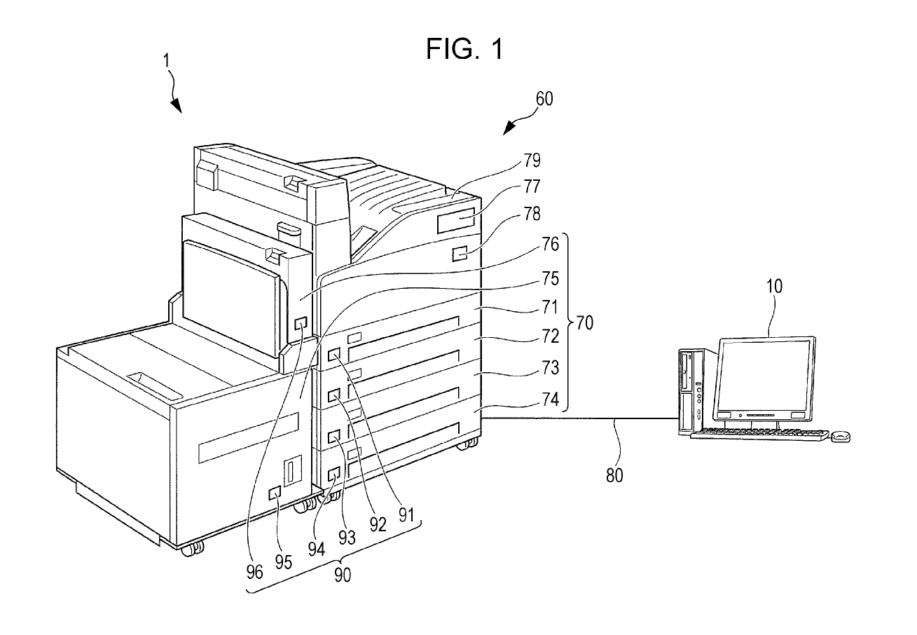

FIG. 1 illustrates an image forming system 1 of an exemplary embodiment.

As illustrated in FIG. 1, the image forming system (printing system) 1 includes a terminal apparatus 10, and an image forming apparatus 60 connected to the terminal apparatus 10 via a network 80.

The terminal apparatus 10 as one example of a print instruction apparatus is a computer configured to instruct the image forming apparatus 60 to print. The terminal apparatus 10 may be a personal computer (PC). The PC herein may operate as a client PC or a server PC.

The image forming apparatus 60 as an example of a printer has an image forming function (printing function) to form an image on a medium, such as a paper sheet. The image forming apparatus 60 may include, besides the image forming apparatus, a multi-function apparatus having an image reading function to read an image from a medium such as a paper sheet, and a facsimile function.

The network 80 is a communication network configured to perform information communications between the terminal apparatus 10 and the image forming apparatus 60. The network 80 may be a local area network (LAN) or the Internet.

The image forming apparatus 60 is described with reference to FIG. 1.

As illustrated in FIG. 1, the image forming apparatus 60 includes an image forming unit (not illustrated) that forms an image on a paper sheet, paper sheet feeder units 70 (not illustrated) that feed loaded paper sheets one by one to the image forming unit, a controller 77 that controls each mechanism in the image forming apparatus 60, a communication interface (I/F) 78 that communicates with the outside, and a user interface (UI) 79 that includes a display panel, receives an instruction from a user, and displays a message to the user. The paper sheet feeder units 70 include a first paper sheet feeder unit 71, a second paper sheet feeder unit 72, a third paper sheet feeder unit 73, a fourth paper sheet feeder unit 74, a fifth paper sheet feeder unit 75, and a sixth paper sheet feeder unit 76. In the following discussion, any one of the first paper sheet feeder unit 71 through the sixth paper sheet feeder unit 76 may be referred to as “the paper sheet feeder unit 70” for convenience of explanation.

The paper sheet feeder unit 70 includes a paper sheet sensor 90 that detects an amount of and a sheet size of paper sheets (remaining amount of paper sheets) loaded therein. The paper sheet sensor 90 may be a contactless sensor using infrared rays.

More specifically, the first paper sheet feeder unit 71, the second paper sheet feeder unit 72, the third paper sheet feeder unit 73, the fourth paper sheet feeder unit 74, the fifth paper sheet feeder unit 75, and the sixth paper sheet feeder unit 76 respectively include a first paper sheet sensor 91, a second paper sheet sensor 92, a third paper sheet sensor 93, a fourth paper sheet sensor 94, a fifth paper sheet sensor 95, and a sixth paper sheet sensor 96.

Each of the first paper sheet sensor 91 through the sixth paper sheet sensor 96 includes a single sensor that detects the remaining amount and the sheet size of paper sheets. Alternatively, each of the first paper sheet sensor 91 through the sixth paper sheet sensor 96 may include multiple sensor devices (not illustrated), one sensor device may detect the remaining amount of paper sheets, and another sensor device may detect the sheet size. In place of or in addition to the sensor detecting the remaining amount of paper sheets, a sensor device detecting zero remaining amount of paper sheets, namely, an out-of-paper state in which paper sheets are no longer available may be included.

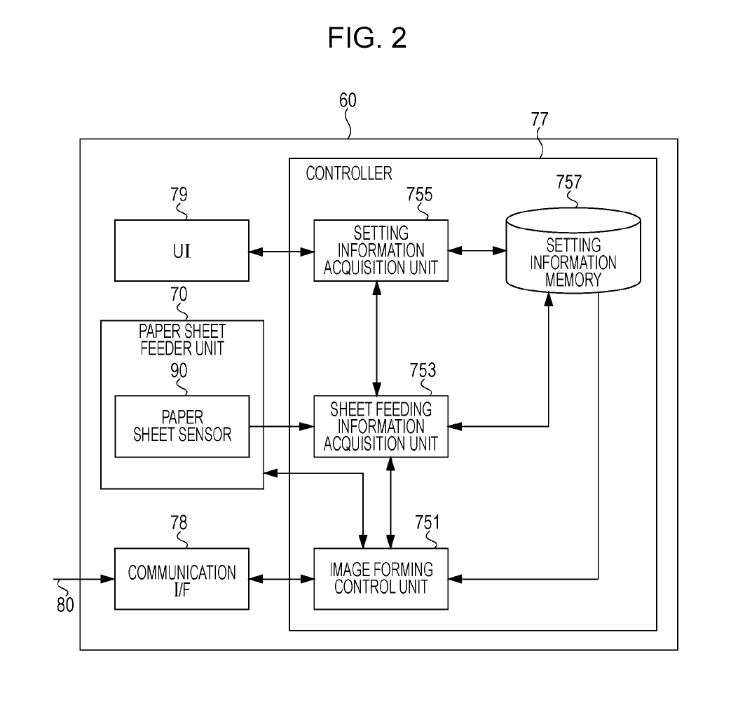

FIG. 2 illustrates a functional configuration of the controller 77 of the exemplary embodiment.

The controller 77 in the image forming apparatus 60 is described with reference to FIG. 2.

The image forming apparatus 60 includes, as the functions of the controller 77, an image forming control unit 751, a sheet feeding information acquisition unit 753, a setting information acquisition unit 755, and a setting information memory 757.

The image forming control unit 751 receives a print instruction from the terminal apparatus 10 via the communication I/F 78, and controls the image forming unit (not illustrated), and the paper sheet feeder unit 70. The image forming control unit 751 stores active feeder unit information that indicates which of the paper sheet feeders 70 is then feeding paper sheets in an image forming operation. In the discussion that follows, a paper sheet feeder unit 70 that feeds paper sheet at a given time point is referred to as an active paper sheet feeder unit.

The image forming control unit 751 generates operation information of the image forming apparatus 60 based on information stored on the setting information memory 757, and outputs the operation information via the communication I/F 78 to the outside. For example, the operation information of the image forming apparatus 60 includes the active feeder unit information, group setting information (described below) and paper feeding information (described below) in the image forming apparatus 60. Error information related to an error occurring in the image forming apparatus 60 is also included. The operation information of the image forming apparatus 60 also includes communication protocols according to which information about an apparatus connected via a communication unit is obtained. For example, the operation information may include management information base (MIB) information based on simple network management protocol (SNMP).

At preset time intervals, the sheet feeding information acquisition unit 753 acquires, from the paper sheet sensor 90 and the image forming control unit 751, paper feeding information related to the paper sheets fed by the paper sheet feeder unit 70. The paper feeding information includes paper sheet information related to the remaining amount and sheet size of paper sheets, and the active feeder unit information.

The setting information acquisition unit 755 acquires from the UI 79 group setting information related to a group setting (described below) of the paper sheet feeder unit 70. The group setting information identifies a feeder unit included in a group.

The setting information memory 757 stores the group setting information acquired by the setting information acquisition unit 755 and the paper feeding information acquired by the sheet feeding information acquisition unit 753. The setting information memory 757 also stores information related to a group setting screen (described below).

The controller 77 includes a central processing unit (CPU) (not illustrated), a memory, and a hard disk drive (HDD). The CPU executes arithmetic processing, thereby implementing the above-described functions. The memory serves as a memory area to store data for use in the execution of a variety of programs. The magnetic disk device serves as a memory area to store input data to a program or output data from the program.

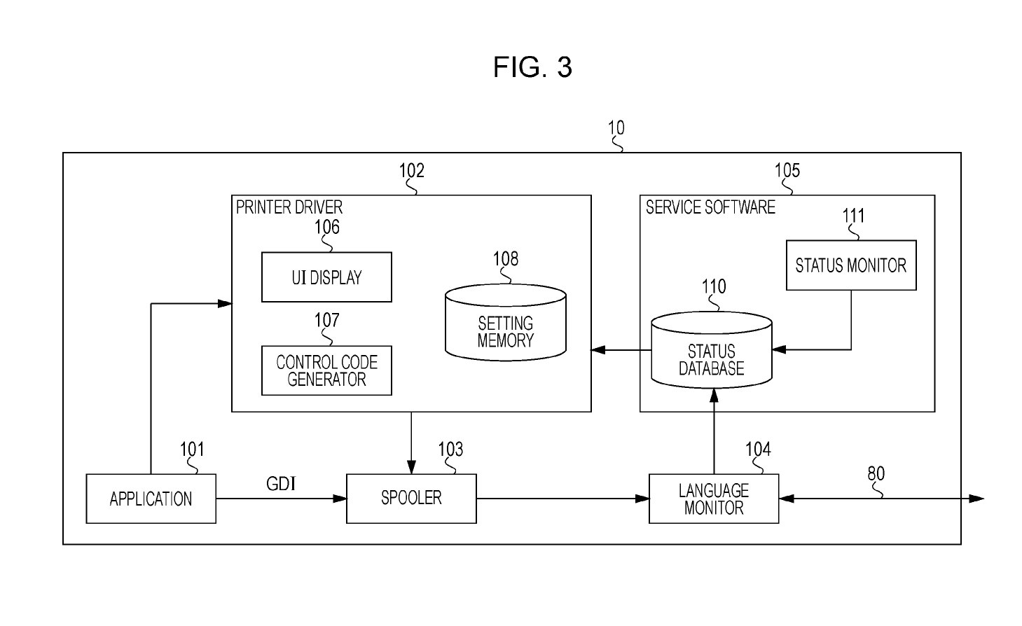

FIG. 3 illustrates a functional configuration of the terminal apparatus 10 of the exemplary embodiment.

The terminal apparatus 10 is described below with reference to FIG. 3.

Referring to FIG. 3, the terminal apparatus 10 includes an application program (hereinafter simply referred to as “application”) 101, a printer driver 102, a spooler 103, a language monitor 104, and service software 105.

The application 101 creates original document data in response to an operation of a user, and retrieves created original document data.

In response to a print request of the original document (print) data from the application 101, the printer driver 102 transmits print instruction data to the image forming apparatus 60 via the spooler 103 and the language monitor 104. The printer driver 102 thus controls the outputting of the original document of the image forming apparatus 60.

The terminal apparatus 10 includes, as functions of the printer driver 102, a UI display 106, a control code generator 107, and a setting memory 108.

The UI display 106 functions as a user interface with the user. More specifically, the UI display 106 presents information to a display mechanism 15 (described below) of the terminal apparatus 10 and receives an operation of the user via the display mechanism 15.

The control code generator 107 generates a control code (print instruction data) instructing the image forming apparatus 60 to print, based on the original document data print-instructed by the application 101.

The setting memory 108 stores information related to the print instruction based on the original document data print-instructed by the application 101. For example, the setting memory 108 stores the number of pages of the original document data transmitted by the application 101.

In response to the print instruction from the printer driver 102, the spooler 103 temporarily stores print instruction data that is to be output to the image forming apparatus 60 via a graphic device interface (GDI) as a rendering instruction of a digital document. The spooler 103 also retrieves the print instruction data in accordance with a predetermined rule and transfers the print instruction data to the language monitor 104. Windows (registered trademark) spooler may be used for the spooler 103.

The language monitor 104 as an example of a group information acquisition unit performs duplex communications with the image forming apparatus 60. The language monitor 104 monitors the image forming apparatus 60 while transmitting page description language (PDL) data to the image forming apparatus 60.

The language monitor 104 queries the image forming apparatus 60 about the operation information at predetermined time intervals to obtain the operation information. For example, the language monitor 104 obtains the operation information using the MIB information of the image forming apparatus 60.

The service software 105 obtains the operation information of the image forming apparatus 60 and notifies the user of the operation information. The service software 105 operates as a status database 110 and a status monitor 111.

The status database 110 stores the operation information of the image forming apparatus 60 notified by the language monitor 104. The status database 110 stores the group setting information and paper feeding information out of the operation information of the image forming apparatus 60 acquired by the language monitor 104.

The status monitor 111 as an example of a display performs a display operation on the display mechanism 15 (described below) of the terminal apparatus 10 at predetermined intervals based on the operation information of the image forming apparatus 60 stored on the status database 110. More specifically, based on the operation information of the image forming apparatus 60, the status monitor 111 determines which of the paper sheet feeder units 70 is an active sheet feeder unit, which group the active sheet feeder unit belongs to, which paper sheet feeder units 70 form the group the active feeder unit belongs to (active feeder group), which of the paper sheet feeder units 70 runs out of paper sheets in the active feeder group, and which of the paper sheet feeder units 70 in the active feeder group is replenishable with paper sheets. Depending on determination results, the status monitor 111 outputs to the UI display 106 an instruction to cause the display mechanism 15 to display a paper feeding status screen 151 (to be discussed later).

The original document data includes information related to styles, including the alignment and size of each page, line feed and character feed width, margin width, delineation of page (end of page), and information related to characters including character code, font, and character size. The print instruction data is PDL data described by page description language. The print instruction data also includes image quality instruction related to the resolution of the printer, tonal gradation, the quality of screen, and rendering instruction of characters, graphics, and images.

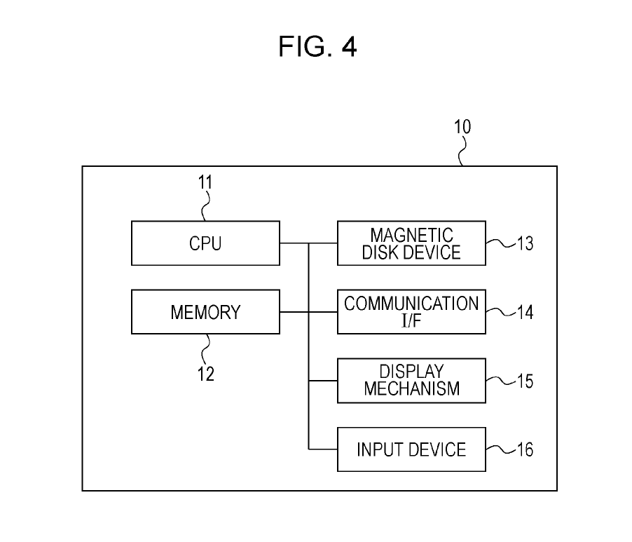

FIG. 4 illustrates a hardware configuration of the terminal apparatus 10.

Referring to FIG. 4, the hardware configuration of the terminal apparatus 10 is described.

The terminal apparatus 10 includes a central processing unit (CPU) 11 as an arithmetic processor, a memory 12, and a hard disk drive (HDD) 13. The CPU 11 executes a variety of software programs including an operating system (OS) and applications, thereby implementing the functions described above. The memory 12 is a storage area configured to store the variety of software programs and data for use in the software programs. The magnetic disk device 13 is a storage area configured to store input data to the software programs and output data from the software programs.

The terminal apparatus 10 further includes a communication interface (I/F) 14 to communicate with the outside, the display mechanism 15 including a video memory and a display, and a input device 16 including a keyboard, a mouse, or the like.

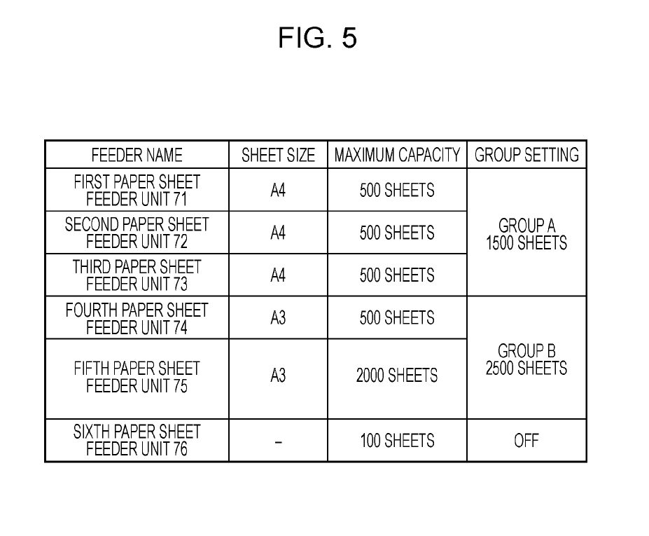

FIG. 5 illustrates a group setting of the paper sheet feeder units 70.

The image forming apparatus 60 of the exemplary embodiment includes multiple paper sheet feeder units 70 (the first paper sheet feeder unit 71 through the sixth paper sheet feeder unit 76). In other words, the image forming apparatus 60 includes multiple paper sheet feeding ports (paper sheet trays) to feed paper sheets.

The image forming apparatus 60 assigns the first paper sheet feeder unit 71 through the sixth paper sheet feeder unit 76 to any group. Upon receiving a print instruction to perform paper feeding based on the assigned group, the image forming apparatus 60 performs a printing operation with paper sheets supplied from one of the paper sheet feeder units 70 in the group. If the paper sheet feeder unit 70 supplying paper sheets runs out of paper sheets (in a state that paper sheets are no longer available), another paper sheet feeder unit 70 in the same group starts to supply paper sheets. In other words, if any one of the paper sheet feeder units 70 in the group runs out of paper sheets, the paper sheet feeding source is automatically changed to another paper sheet feeder unit 70 in the same group (without waiting for an operation by the user).

The group is set up by the user. For example, the group is set in accordance with the sheet size of paper sheets loaded in the paper sheet feeder units 70.

Referring to FIG. 5, the group setting is described specifically. As illustrated in the example of FIG. 5, The first paper sheet feeder unit 71 through the third paper sheet feeder unit 73 are loaded with paper sheets of A4 sheet size. The fourth paper sheet feeder unit 74 and the fifth paper sheet feeder unit 75 are loaded with paper sheets of A3 sheet size. The sixth paper sheet feeder unit 76, which is a manual feeding tray, is not loaded with any paper sheets. As for the maximum capacity of the paper sheet feeder units 70, each of the first paper sheet feeder unit 71 through the fourth paper sheet feeder unit 74 has a capacity of 500 sheets, the fifth paper sheet feeder unit 75 has a capacity of 2000 sheets, and the sixth paper sheet feeder unit 76 has a capacity of 100 sheets.

The first paper sheet feeder unit 71 through the third paper sheet feeder unit 73 with the paper sheets of the sheet size A4 loaded therewithin are set to be a group A. The fourth paper sheet feeder unit 74 and the fifth paper sheet feeder unit 75 with the paper sheets of the sheet size A3 loaded therewithin are set to be a group B. The sixth paper sheet feeder unit 76 is not set up to be any group.

If a print instruction with sheet feeding to be performed from the group A is received in this setting, the paper feeding starts with the first paper sheet feeder unit 71. If the first paper sheet feeder unit 71 runs out of paper sheets, the second paper sheet feeder unit 72 starts feeding paper sheets. If the second paper sheet feeder unit 72 runs out of paper sheets, the third paper sheet feeder unit 73 then starts feeding paper sheets. Paper feeding is thus continuously performed in the order of the first paper sheet feeder unit 71 through the third paper sheet feeder unit 73 forming the group A.

With the group setting described above, the maximum capacity as the group A is a total maximum capacity of the first paper sheet feeder unit 71 through the third paper sheet feeder unit 73, namely, 1500 sheets. The maximum capacity as the group B is a total maximum capacity of the fourth paper sheet feeder unit 74 and the fifth paper sheet feeder unit 75, namely, 2500 sheets. In other words, with the group setting, the user is provided with a single paper sheet feeder as a combination of multiple paper sheet feeder units 70, namely, a large-capacity paper sheet feeder.

The two groups (the groups A and B) are set up in the paper sheet feeder units 70 in FIG. 5. Alternatively, a single group, or three or more groups may be set up. The group setting is dependent on the sheet size herein. The exemplary embodiment is not limited to this arrangement. In place of or in addition to the sheet size, the group setting may be performed depending on the alignment according to which the paper sheets are fed (with the long side or short side being a leading edge of each paper sheet in the feeding direction), the type of paper sheets (whether the paper sheet is perforated type or not, whether the paper sheets are coated type or not), and other condition including the thickness of each paper sheet.

The order of paper feeding in the group may be set to be any sequence. The paper sheet feeder units 70 may be used in the order of small to large reference number or large to small reference number. The paper sheet feeder units 70 may be used in the order of from large to small capacity.

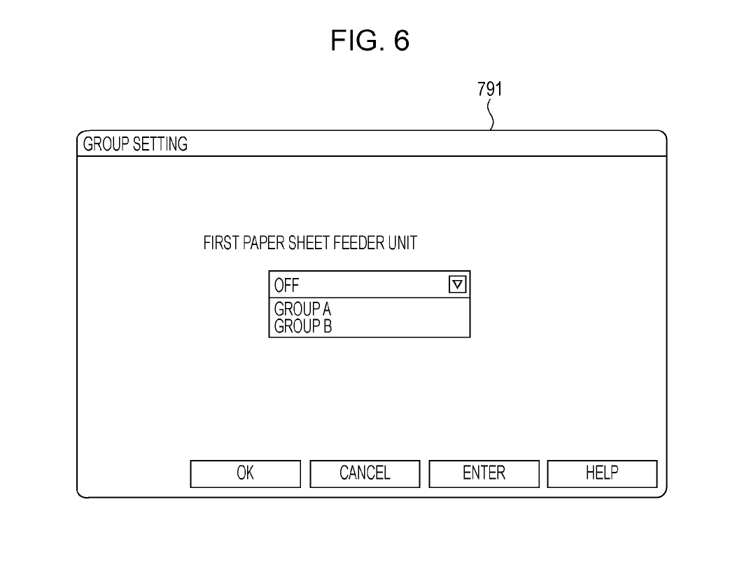

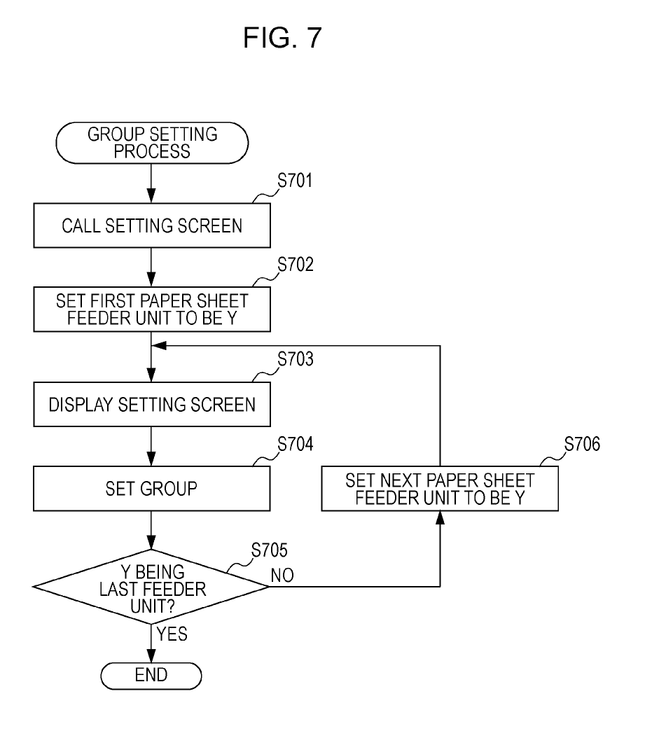

FIG. 6 illustrates an example of a first group setting screen 791 displayed on the UI 79 in the image forming apparatus 60. FIG. 7 is a flowchart illustrating an operation example of the group setting in the image forming apparatus 60.

The group setting operation by the user is described below. The group setting screen displayed on the UI 79 in the image forming apparatus 60 is described with reference to FIG. 6, and then a specific operation example of the group setting is described with reference to FIG. 7.

As illustrated in FIG. 6, an operation by the user on the UI 79 triggers the displaying of the group setting screen on the UI 79 in the image forming apparatus 60 before the image forming starts on the image forming apparatus 60. The first paper sheet feeder unit 71 through the sixth paper sheet feeder unit 76 have their own group setting screens, and a first group setting screen 791 as the setting screen of the first paper sheet feeder unit 71 is described, for example. The group setting screen is stored on the setting information memory 757.

The group setting of the first paper sheet feeder unit 71 is performed on the first group setting screen 791.

More specifically, when the user operates the first group setting screen 791, the UI 79 displays a list of group settings. As illustrated in FIG. 6, “off” included in the list of group setting refers to no group setting (the first paper sheet feeder unit 71 alone feeds paper sheets). The “group A” indicates that the first paper sheet feeder unit 71 is set up to be in the group A, and the “group B” indicates that the first paper sheet feeder unit 71 is set up to be in the group B. The user may select any of these settings, and then presses an “OK” button. The group setting of the first paper sheet feeder unit 71 is thus acquired by the setting information acquisition unit 755, and stored on the setting information memory 757.

This operation is performed on each of the second paper sheet feeder unit 72 through the sixth paper sheet feeder unit 76 in addition to the first paper sheet feeder unit 71, thereby completing the group setting on the image forming apparatus 60. The image forming control unit 751 controls the paper sheet feeder unit 70 based on the group setting stored on the setting information memory 757 and performs image forming, though this operation is not discussed in detail herein.

A specific operation of the group setting process is described with reference to FIG. 7.

The group setting screen is called in response to an operation of the user on the UI 79 (step S701), in a state prior to the start of the image forming on the image forming apparatus 60 (for example, before the image forming apparatus 60 receives a print instruction from the terminal apparatus 10). The setting information acquisition unit 755 sets the first paper sheet feeder unit 71 to Y (step S702), and the group setting screen of Y (see the first group setting screen 791 of FIG. 6) is displayed on the UI 79 (step S703). As described with reference to FIG. 6, the group Y is set up in accordance with the displayed group setting screen. The group setting is thus stored on the setting information memory 757 (step S704).

The setting information acquisition unit 755 determines whether Y is last in the paper sheet feeder units 70 (step S705). If Y is not last in the paper sheet feeder units 70 (no branch from step S705), the setting information acquisition unit 755 sets a next paper sheet feeder unit (the second paper sheet feeder unit 72, for example) to Y (step S706). The group setting screen of the second paper sheet feeder unit of Y is displayed on the UI 79 (step S703). If Y is last in the paper sheet feeder units 70 (yes from step S705), the group setting process ends.

The group setting of the paper sheet feeder units 70 performed by the user has been described. Alternatively, the group setting may be pre-stored on the setting information memory 757. Alternatively, during the group setting, the paper sheet sensor 90 detects the sheet size of the paper sheets loaded in the paper sheet feeder unit 70, and the setting information acquisition unit 755 may perform the group setting depending on the detected sheet size. The group setting may be performed by the terminal apparatus 10.

It is typically difficult for a user to know an amount of paper sheets loaded in each of the paper sheet feeder units 70 from outside of the image forming apparatus 60. Even after the group setting is completed, the timing of an image forming interruption is advanced if one of the paper sheet feeder units 70 in the group runs out of paper sheets or has only a small remaining amount of paper sheets. As a result, time to complete image forming may be prolonged or the frequency of occurrence of an image forming interruption may be increased. If one of the paper sheet feeder units 70 runs out of paper sheets, it is difficult to learn which paper sheet feeder unit 70 suffers from paper shortage in which group. The replenishment operation of the paper sheets to the paper sheet feeder unit 70 may not be smoothly performed.

In the exemplary embodiment, the status monitor 111 recognizes a paper sheet feeder unit 70 replenishable with paper sheets based on the operation information of the image forming apparatus 60, and displays the operation information.

Since the information related to the paper sheet feeder unit 70 replenishable with paper sheets is displayed, the user may replenish the paper sheet feeder unit 70 with paper sheets prior to an image forming interruption, and may thus reduce the frequency of occurrence of the image forming interruption.

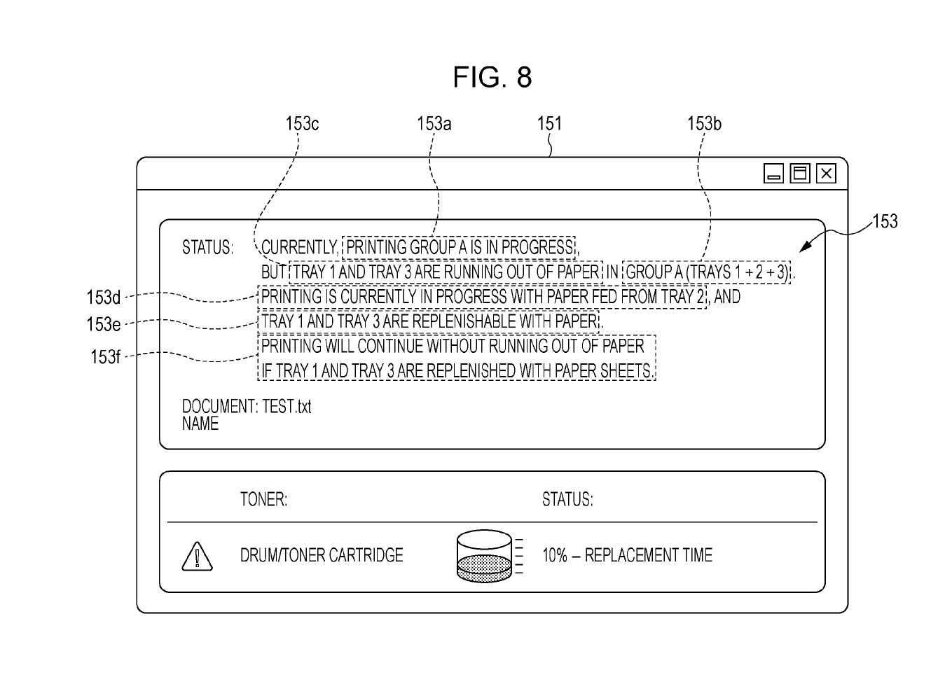

FIG. 8 illustrates an example of a paper feeding status screen 151 displayed on the display mechanism 15 in the terminal apparatus 10.

The paper feeding status screen 151 is described below with reference to FIG. 8. The paper feeding status screen 151 displays the information related to the paper sheet feeder unit 70 replenishable with paper sheets.

Referring to FIG. 8, the status monitor 111 displays the paper feeding status screen 151 while the image forming apparatus 60 performs the image forming operation. The paper feeding status screen 151 indicates a paper feeding status in the image forming apparatus 60, and is displayed on the display mechanism 15.

The paper feeding status screen 151 includes a paper feeding status notification image 153 to notify the user of the paper feeding status. The paper feeding status notification image 153 in turn includes an active group image 153a, a group image 153b, an out-of-paper image 153c, an active feeder unit image 153d, a replenishable feeder unit image 153e, and a replenishment prompting screen 153f.

The active group image 153a indicates which group is active in the paper feeding, in other words, indicates which group an active feeder unit is in. In the example of FIG. 8, the group A feeds paper sheets (prints images).

The group image 153b is an example of information related to the paper sheet feeder units forming a group. The group image 153b indicates the paper sheet feeder units 70 forming a group (active feeder group) to which an active paper feeder unit belongs. As illustrated in FIG. 8, the group A feeding paper sheets includes the first paper sheet feeder unit 71 (tray 1), the second paper sheet feeder unit 72 (tray 2), and the third paper sheet feeder unit 73 (tray 3).

The out-of-paper image 153c is an example of information related to a paper sheet feeder unit that is to be replenished with paper sheets in the group. The out-of-paper image 153c indicates which paper sheet feeder unit 70 runs out of paper sheets in the active feeder group. As illustrated in FIG. 8, the out-of-paper image 153c indicates that the first paper sheet feeder unit 71 and the third paper sheet feeder unit 73 run out of paper sheets. The paper sheet feeder unit 70 that runs out of paper sheets is considered to be a paper sheet feeder unit 70 that is to be replenished soon.

The active feeder unit image 153d is an example of information related to a paper sheet feeder unit that is active in paper feeding in the group. The active feeder unit image 153d indicates the paper sheet feeder unit 70 that is feeding paper sheets. In the example of FIG. 8, the second paper sheet feeder unit 72 is feeding paper sheets.

The replenishable feeder unit image 153e is an example of information related to a paper sheet feeder unit replenishable with paper sheets in the group. The replenishable feeder unit image 153e indicates which paper sheet feeder unit 70 is replenishable with paper sheets in the active feeder group. In the example of FIG. 8, the first paper sheet feeder unit 71 and the third paper sheet feeder unit 73 are replenishable with paper sheets.

The replenishment prompting screen 153f prompts the user to replenish paper sheets. As illustrated in FIG. 8, printing may be continuously performed without paper shortage if the first paper sheet feeder unit 71 and the third paper sheet feeder unit 73 are replenished with paper sheets.

The paper feeding status notification image 153 herein includes the active group image 153a, the group image 153b, the out-of-paper image 153c, the active feeder unit image 153d, the replenishable feeder unit image 153e, and the replenishment prompting screen 153f. Alternatively, only one of these images may be displayed or multiple images of these image may be displayed in combination. For example, only the replenishable feeder unit image 153e may be displayed, or only the out-of-paper image 153c may be displayed, or only the replenishment prompting screen 153f may be displayed.

Referring to FIG. 8, the paper feeding status notification image 153 is displayed in text. Alternatively, the paper feeding status notification image 153 may be displayed using graphics. For example, the replenishable feeder unit image 153e may indicate a location of the paper sheet feeder unit 70 that is replenishable with paper sheets in the general view of the image forming apparatus 60. If the paper sheet feeder unit 70 is displayed in this way, the user may easily recognize the paper sheet feeder unit 70 replenishable with paper sheets. As long as the user is notified of the paper feeding status, another form of notification, such as a voice alert, may be employed in place of or in addition to displaying the images.

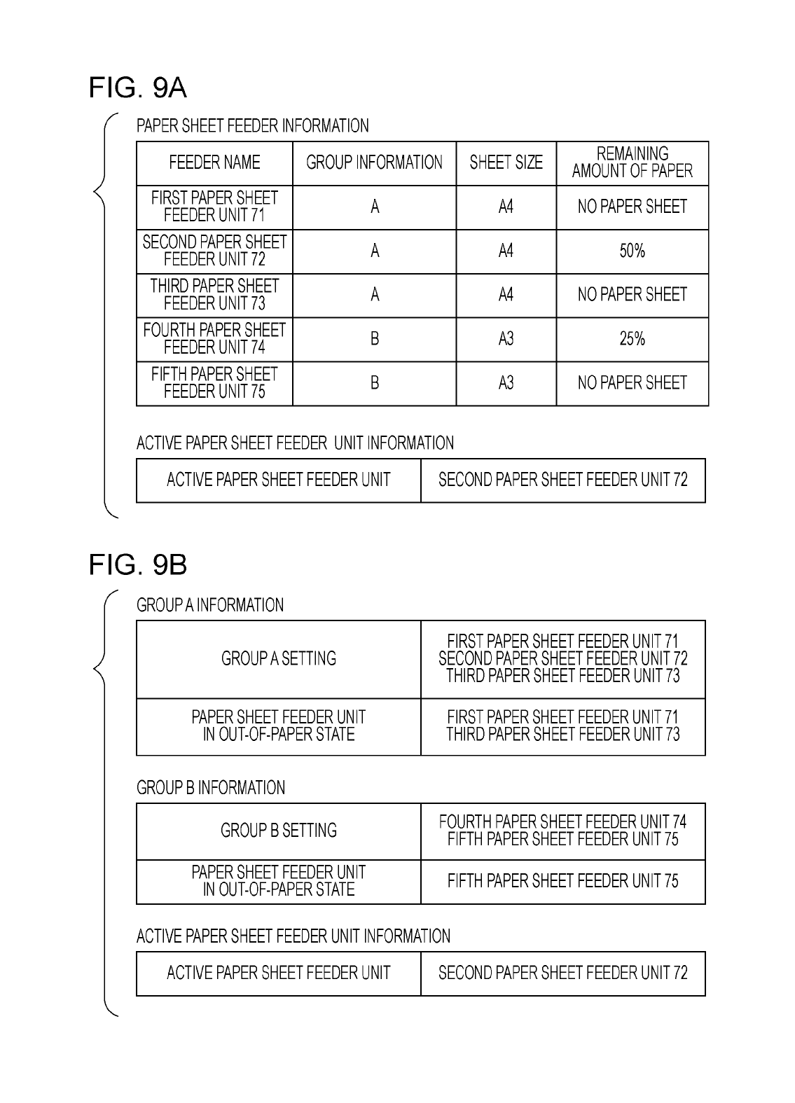

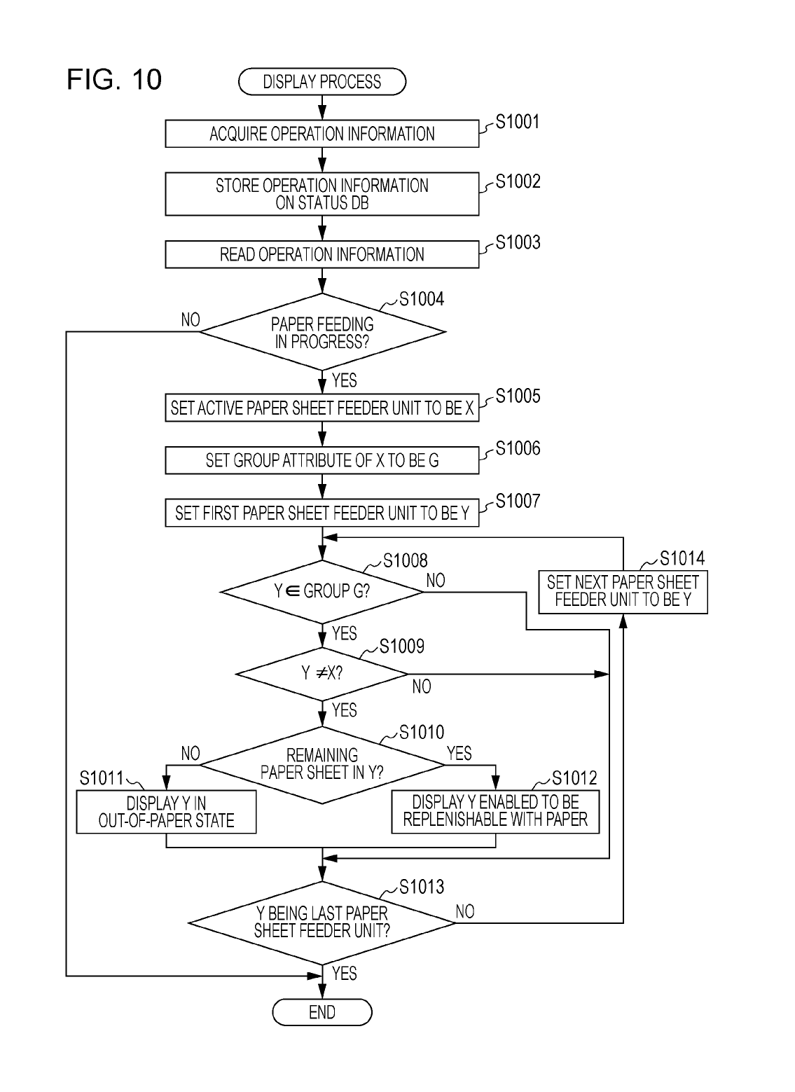

FIG. 9A illustrates the paper feeding information and group setting information stored on the setting information memory 757, and FIG. 9B illustrates the paper feeding information and group setting information stored on the status database 110. FIG. 10 is a flowchart illustrating an example of a display process of the paper feeding status screen 151.

The display process of the paper feeding status screen 151 is described. The information stored on the setting information memory 757 and the status database 110 is described first with reference to FIG. 9A and FIG. 9B, and a specific display process of the paper feeding status screen 151 is described with reference to FIG. 10.

As illustrated in FIG. 9A, the setting information memory 757 stores the paper feeding information acquired by the sheet feeding information acquisition unit 753 at predetermined time intervals, and the group setting information acquired by the setting information acquisition unit 755 prior to the image forming operation. In the example of FIG. 9A, the setting information memory 757 stores information that the first paper sheet feeder unit 71 is set up to be in the group A and configured to be loaded with paper sheets of sheet size A4, and has no remaining paper sheets, namely, runs out of paper sheets. The second paper sheet feeder unit 72 is set up to be in the group A and configured to be loaded with paper sheets of sheet size A4, and has a remaining amount equal to 50 percent of the maximum capacity thereof. The third paper sheet feeder unit 73 is set up to be in the group A and configured to be loaded with paper sheets of sheet size A4, and runs out of paper sheets. The fourth paper sheet feeder unit 74 is set up to be in the group B and configured to be loaded with paper sheets of sheet size A3, and has a remaining amount equal to 25 percent of the maximum capacity thereof. The fifth paper sheet feeder unit 75 is set up to be in the group B and configured to be loaded with paper sheets of sheet size A3, and runs out of paper sheets. The setting information memory 757 also stores these pieces of information.

The setting information memory 757 further stores information related to an active paper feeder unit. In the example of FIG. 9, the second paper sheet feeder unit 72 feeds paper sheets.

The image forming control unit 751 outputs the information stored on the setting information memory 757 to the outside as the operation information of the image forming apparatus 60.

The status database 110 of FIG. 9B reorganizes the operation information of the image forming apparatus 60 acquired via the language monitor 104 and then stores the reorganized operation information. As illustrated in FIG. 9B, the group A information indicates that the group A includes the first paper sheet feeder unit 71, the second paper sheet feeder unit 72, and the third paper sheet feeder unit 73, and that the first paper sheet feeder unit 71 and the third paper sheet feeder unit 73 run out of paper sheets. The operation information of the image forming apparatus 60 also indicates that the group B includes the fourth paper sheet feeder unit 74 and the fifth paper sheet feeder unit 75 and that the fifth paper sheet feeder unit 75 runs out of paper sheets.

The status database 110 stores the information of the active paper sheet feeder unit. In the example of FIG. 9B, the second paper sheet feeder unit 72 is feeding paper sheets.

A specific operation to display the paper feeding status screen 151 is described below. Referring to FIG. 10, the language monitor 104 acquires the operation information including the paper feeding information and group setting information (step S1001). The operation information acquired by the language monitor 104 is stored on the status database (DB) 110 (step S1002).

The status monitor 111 reads the operation information, including the paper feeding information and group setting information, stored on the status database 110 (step S1003).

The status monitor 111 determines whether the image forming apparatus 60 is currently printing, namely, is feeding paper sheets (step S1004). If the image forming apparatus 60 is currently feeding paper sheets (yes branch from step S1004), the status monitor 111 sets the paper sheet feeder unit currently feeding paper sheets to be X (step S1005). Since the second paper sheet feeder unit 72 is feeding paper sheets in FIG. 9B, the second paper sheet feeder unit 72 is set to be X. The status monitor 111 sets the group attribute of X to be G based on the read group setting information (step S1006). Since the second paper sheet feeder unit 72 belongs to the group A, the group A is set to be G.

The status monitor 111 sets the first paper sheet feeder unit 71 to be Y (step S1007). The status monitor 111 determines whether Y belongs to G, namely, whether the first paper sheet feeder unit 71 belongs to the group A (step S1008). If Y belongs to G (yes branch from step S1008), the status monitor 111 determines whether X is different from Y (step S1009). If X is different from Y (yes branch from step S1009), the status monitor 111 determines the remaining amount of paper sheets of Y, in this case, whether there is a remaining amount of paper sheets in the first paper sheet feeder unit 71 (step S1010).

If there is no remaining amount of paper sheets (no branch from step S1010), the status monitor 111 indicates that Y runs out of paper sheets (step S1011). More specifically, the status monitor 111 notifies the user via the out-of-paper image 153c of FIG. 8 that the first paper sheet feeder unit 71 runs out of paper sheets. On the other hand, if there is a remaining amount of paper sheets in Y (yes branch from step S1010), the status monitor 111 indicates that Y is replenishable with paper sheets (step S1012). More specifically, the status monitor 111 notifies the user via the replenishable feeder unit image 153e of FIG. 8 that the first paper sheet feeder unit 71 is replenishable with paper sheets.

The status monitor 111 determines whether Y is last in the paper sheet feeder units 70 (step S1013). If Y is not last in the paper sheet feeder units 70 (no branch from step S1013), the status monitor 111 sets a next paper sheet feeder unit (the second paper sheet feeder unit 72, for example) to be Y (step S1014), and then determines whether the paper sheet feeder unit as Y belongs to G (step S1008). If Y is last in the paper sheet feeder units 70 (yes branch from step S1013), the display process of the paper feeding status screen 151 is completed.

If the image forming apparatus 60 is not feeding paper sheets (no branch from step S1004), the display process of the paper feeding status screen 151 is complete. If Y does not belong to G (no branch from step S1008), or if X equals Y (no branch in step S1009), the status monitor 111 determines whether Y is last in the paper sheet feeder units 70 (step S1013).

The status monitor 111 iterates the display process of the paper feeding status screen 151 at predetermined time intervals, thereby updating the paper feeding status screen 151 displayed on the display mechanism 15 of the terminal apparatus 10.

In the exemplary embodiment, the printing status of the image forming apparatus 60 is monitored by the status monitor 111 rather than by the printer driver 102. In this arrangement, the printing status of the image forming apparatus 60 may be continuously monitored (print instruction data is managed) even after the print instruction data (print spool data) from the printer driver 102 is stored on the spooler 103.

However, the printing status of the image forming apparatus 60 may be monitored by the printer driver 102. The exemplary embodiment is not intended to exclude the arrangement that the printing status of the image forming apparatus 60 is monitored by the printer driver 102.

In the discussion of FIG. 10, if a paper sheet feeder unit 70 is determined to be replenishable if the paper sheet feeder unit 70 is not an active paper sheet feeder unit (yes branch from step S1009), and still has a remaining amount of paper sheets (yes branch from step S1010).

The following modifications to the exemplary embodiment are possible.

The paper sheet feeder unit 70 having a remaining amount of paper sheets smaller than a threshold value may be determined to be unable to feed paper sheets.

The paper sheet feeder units 70 may be aligned with a direction of paper transport of paper sheets. If a paper sheet feeder unit 70 located downstream in the direction of paper transport is replenished with paper sheets while a paper sheet feeder unit 70 located upstream in the direction of paper transport is feeding paper sheets, paper replenishment may interfere with paper transporting from the upstream paper sheet feeder unit 70. In this arrangement, the downstream paper sheet feeder unit 70 is not replenished while the upstream paper sheet feeder unit 70 feeds paper sheets. The setting information memory 757 may pre-store information concerning a paper sheet feeder unit (non-replenishable paper feeder unit) 70 that is not replenishable in relation to a paper sheet feeder unit (active paper sheet feeder unit) 70 that is feeding paper sheets. Based on the information, the status monitor 111 may determine whether each paper sheet feeder unit 70 is replenishable or not.

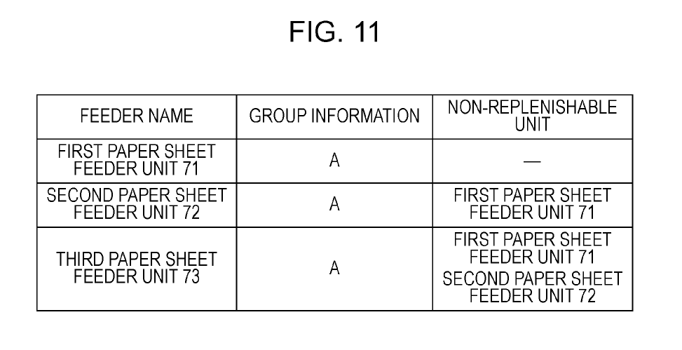

Referring to FIG. 11, the above example is specifically described. FIG. 11 illustrates an inhibition relationship of paper feeding in anther exemplary embodiment. More in detail, FIG. 11 illustrates the relationship between the active paper sheet feeder unit and the non-replenishable paper sheet feeder unit in the group A including the first paper sheet feeder unit 71 through the third paper sheet feeder unit 73.

It is assumed as illustrated in FIG. 1 that the third paper sheet feeder unit 73, the second paper sheet feeder unit 72, and the first paper sheet feeder unit 71 are arranged in this order from upstream to downstream in the direction of paper transport. If the first paper sheet feeder unit 71 or the second paper sheet feeder unit 72 is pulled out in this arrangement with the third paper sheet feeder unit 73 feeding paper sheets, the paper sheets from the third paper sheet feeder unit 73 located upstream jam at the location where the first paper sheet feeder unit 71 or the second paper sheet feeder unit 72 is pulled. Paper jamming thus occurs. If the first paper sheet feeder unit 71 is pulled out with the second paper sheet feeder unit 72 feeding paper sheets, the paper sheets from the second paper sheet feeder unit 72 located upstream jam where the first paper sheet feeder unit 71 is pulled out.

The relationship between the active paper sheet feeder unit and the non-replenishable paper sheet feeder unit is determined such that no paper jamming occurs.

More specifically, if the first paper sheet feeder unit 71 is an active paper sheet feeder unit as illustrated in FIG. 11, there is no non-replenishable paper sheet feeder unit in the group A. If the second paper sheet feeder unit 72 is an active paper sheet feeder unit, the first paper sheet feeder unit 71 becomes a non-replenishable paper sheet feeder unit. If the third paper sheet feeder unit 73 is an active paper sheet feeder unit, the first paper sheet feeder unit 71 and the second paper sheet feeder unit 72 become non-replenishable paper sheet feeder units.

The setting information memory 757 pre-stores the relationship (inhibition relationship) between the active paper sheet feeder unit and the non-replenishable paper sheet feeder unit. In the process of FIG. 10, the status monitor 111 determines whether there is a remaining amount of paper sheets (see step S1010) and then determines based on the information stored on the setting information memory 757 whether the paper replenishment is inhibited or not. If the paper replenishment is not inhibited in this determination, the status monitor 111 indicates that the paper sheet feeder unit 70 is replenishable (step S1012). If the paper replenishment is inhibited in this determination, the status monitor 111 does not indicate that the paper sheet feeder unit 70 is replenishable.

In the exemplary embodiments described above, the paper feeding status screen 151 is displayed on the display mechanism 15 in the terminal apparatus 10. The paper feeding status screen 151 may also be displayed on the image forming apparatus 60. More specifically, the paper feeding status screen 151 may be displayed on the display mechanism 15 in the terminal apparatus 10 and/or on the UI 79 in the image forming apparatus 60.

In the exemplary embodiments described above, the status monitor 111 in the terminal apparatus 10 determines the paper sheet feeder unit 70 that is an active paper sheet feeder unit, determines the group the active paper sheet feeder unit belongs to, determines the paper sheet feeder unit 70 that forms the active feeder group, determines the paper sheet feeder unit 70 that runs out of paper sheets in the active feeder group, and determines the paper sheet feeder unit 70 that is replenishable in the active feeder group. These determination operations may be performed by the image forming apparatus 60. For example, all these determination operations may be performed by the image forming control unit 751. These determination operations may also be performed by the image forming control unit 751 and the status monitor 111.

In the exemplary embodiments described above, the status monitor 111 performs these determination operations during paper feeding. Furthermore, the determination operations may be performed not only during paper feeding, but also prior to image forming (before the start of paper feeding) or subsequent image forming (after the end of paper feeding). The determination results may be displayed on the display mechanism 15 in the terminal apparatus 10. The determination operations may be performed within a predetermined period of time during paper feeding, and the determination results thereof may be displayed.

The program implementing the exemplary embodiments may be supplied not only via a communication line but also via a recording medium, such as a compact disc read-only memory (CD-ROM), with the program stored thereon.

The exemplary embodiments and the modifications thereof have been described. The exemplary embodiments and the modifications thereof may be implemented in combination.

The disclosure is not limited to the exemplary embodiments and may be implemented in a variety of forms without departing from the disclosure.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A print instruction apparatus comprising:
a group information acquisition unit that acquires information identifying a feeder unit included in a group that includes two or more feeder units, from among a plurality of feeder units arranged in a printer to feed paper sheets, and that is configured in a manner such that if one of the feeder units in the group runs out of paper sheets in a printing operation of the printer, another feeder unit in the group starts to feed paper sheets; and
a display that acquires information related to a remaining amount of paper sheets or information related to an out-of-paper state in each of the feeder units in the group that is configured to feed paper sheets in the printing operation, and that displays information related to a feeder unit in the group that is to be replenished with paper sheets.

2. The print instruction apparatus according to claim 1, wherein the display identifies an active feeder unit that is feeding paper sheets in the group, and does not display information related to the active feeder unit as information related to the feeder unit that is to be replenished with paper sheets.

3. The print instruction apparatus according to claim 1, wherein the display displays information related to a feeder unit in the group that has no paper sheets.

4. The print instruction apparatus according to claim 2, wherein the display displays information related to a feeder unit in the group that has no paper sheets.

5. The print instruction apparatus according to claim 1, wherein the display displays information related the feeder units forming the group, and information related to the active feeder unit that is feeding paper sheets.

6. The print instruction apparatus according to claim 2, wherein the display displays information related the feeder units forming the group, and information related to the active feeder unit that is feeding paper sheets.

7. The print instruction apparatus according to claim 3, wherein the display displays information related the feeder units forming the group, and information related to the active feeder unit that is feeding paper sheets.

8. The print instruction apparatus according to claim 4, wherein the display displays information related the feeder units forming the group, and information related to the active feeder unit that is feeding paper sheets.

9. A print instruction apparatus comprising:
a group information acquisition unit that acquires information identifying a feeder unit included in a group that includes two or more feeder units, from among a plurality of feeder units arranged in a printer to feed paper sheets, and that is configured in a manner such that if one of the feeder units in the group runs out of paper sheets in a printing operation of the printer, another feeder unit in the group starts to feed paper sheets; and
a display that acquires information identifying an active feeder unit that is feeding paper sheets from among the feeder units in the group that is configured to feed paper sheets in the printing operation, and that displays information related to a feeder unit in the group that is to be replenished with paper sheets.

10. A printing system comprising:
a printer including a plurality of feeder units that feed paper sheets;
a print instruction apparatus that instructs the printer to print an image;
a group information acquisition unit that acquires information identifying a feeder unit included in a group that includes two or more feeder units, from among a plurality of feeder units arranged in a printer to feed paper sheets, and that is configured in a manner such that if one of the feeder units in the group runs out of paper sheets in a printing operation of the printer, another feeder unit in the group starts to feed paper sheets; and
a display that acquires information related to a remaining amount of paper sheets or information related to an out-of-paper state in each of the feeder units in the group that is configured to feed paper sheets in the printing operation, and that displays information related to a feeder unit in the group that is to be replenished with paper sheets.

11. A print instruction method comprising:
acquiring information identifying a feeder unit included in a group that includes two or more feeder units, from among a plurality of feeder units arranged in a printer to feed paper sheets, and that is configured in a manner such that if one of the feeder units in the group runs out of paper sheets in a printing operation of the printer, another feeder unit in the group starts to feed paper sheets; and
acquiring information related to a remaining amount of paper sheets or information related to an out-of-paper state in each of the feeder units in the group that is configured to feed paper sheets in the printing operation, and displaying information related to a feeder unit in the group that is to be replenished with paper sheets.

12. A non-transitory computer readable medium storing a program causing a computer to execute a process for printing an image, the process comprising:
acquiring information identifying a feeder unit included in a group that includes two or more feeder units, from among a plurality of feeder units arranged in a printer to feed paper sheets, and that is configured in a manner such that if one of the feeder units in the group runs out of paper sheets in a printing operation of the printer, another feeder unit in the group starts to feed paper sheets; and
acquiring information related to a remaining amount of paper sheets or information related to an out-of-paper state in each of the feeder units in the group that is configured to feed paper sheets in the printing operation, and displaying information related to a feeder unit in the group that is to be replenished with paper sheets.
